(19) United States
(12) Patent Application Publication
(10) Pub. No.: US 2008/0121045 A1
(43) Pub. Date: May 29, 2008

(54) MULTIPLEXED SENSOR ARRAY

(76) Inventors: Matthew C. Cole, Livonia, NY (US); Paul J.A. Kenis, Champaign, IL (US)

Correspondence Address: EVAN LAW GROUP LLC, 600 WEST JACKSON BLVD., SUITE 625, CHICAGO, IL, 60661, US

(21) Appl. No.: 11/564,779

(22) Filed: Nov. 29, 2006

(51) Int. Cl. G01F 1/56

(52) U.S. Cl. 73/861.08

(57) ABSTRACT

A sensor array includes a plurality of q sensors, a common output lead electrically connected to each sensor, a plurality of m primary input leads each primary input lead electrically connected to n of the plurality of sensors, and a plurality of n secondary input leads each secondary input lead electrically connected to m of the plurality of sensors. The number of sensors q=m·n, m is at least 2, n is at least 2, and each sensor is electrically connected to one of the plurality of primary input leads and one of the plurality of secondary input leads.

### FEDERALLY SPONSORED RESEARCH OR DEVELOPMENT

This subject matter of this application may have been funded in part under the following research grants and contracts: National Science Foundation Award No. DMI-0328162. The U.S. Government may have rights in this invention.

### BACKGROUND

As microfluidic devices continue to decrease in size and increase in complexity, the ability to monitor the passage of material throughout them becomes ever more important. In recent years, microfluidic systems have been used in many chemical and biological applications, such as DNA analysis [1], capillary electrophoresis [2], cell cytometry [3], high throughput screening for combinatorial chemistry [4], membraneless fuel cells [5], and combining multiple biological assays onto a single chip [6]. However, as impressive as these devices are, they are more or less “black box” systems, in that, one typically has little to no knowledge of how or where material is moving through them. For simple, single channel devices, this is not a problem. But as simple devices continue to be scaled up into large arrays, detection, routing, and scheduling do become significant issues.

For microfluidic devices to continue to evolve, they will eventually need to incorporate a real time routing and scheduling control system. Such a control system depends on the ability to create large arrays of robust sensors capable of detecting the position of material throughout a microfluidic network [7]. Ideally, the sensors used should be easy to fabricate and integrate with current microfluidic devices, require a small footprint of space on the device, and consume only a small amount of power.

Numerous reports and reviews have appeared in the literature on various types of sensing in microfluidic devices. Optical detection techniques based on fluorescence [8, 9], absorbance [8, 9], luminescence [10], and waveguides [11, 12] are the most prevalent. Others have used some form of electrochemical detection during electrophoretic separations, including amperometry [13-16], conductimetry [17-20], and potentiometry [20-22]. While still others have used electrical sensors such as resistors [23-26], capacitors [27-31], and conduction gaps [32-37], as simplified versions of the electrochemical methods given above, for detection in other types of microfluidic devices. Although most of these examples describe either the detection of individual molecules or biological cells, or the measurement of specific fluid properties (concentration, temperature, flow rate, etc.), considering their sensing principles as applied to the detection of a discrete liquid element at a specified position in a microfluidic network is straightforward.

Electrical sensors best meet the criteria necessary for a microfluidic control system as described above [38]. While most optical sensing methods rely heavily on equipment external to the chip itself (such as a light source and a detector), electrical sensors can be incorporated directly onto the substrate of a given microfluidic device because of their minimal thickness. They are easy to fabricate by standard photolithographic techniques, and generally require only a small amount of power for operation. For the purposes of liquid detection, electrical sensors act by simply applying a small constant current or potential across a sensing element (either a resistor, capacitor, or conduction gap) in a microchannel, and continually monitoring the corresponding output signal. A change in the output indicates a change in the liquid surrounding the sensor, thereby detecting when a liquid element of different composition is present at a certain point.

To fully realize the goal of a microfluidic control system, these individual electrical sensors must be integrated into a large array spanning an entire microfluidic network. A major problem associated with this is that as the number of sensors increases, so too does the number of electrical leads necessary to connect the sensors with external monitoring equipment. This rapid growth can make the fabrication and implementation of the sensor array exceedingly difficult [39-41]. Previous work has been reported on obtaining densely packed arrays of sensors by electroplating electrodes on the back side of a device substrate and connecting them to the sensors via through-holes created by the wet etching of the polyimide substrate [7]. Others have used arrays of different metal oxide sensors with partially overlapping sensitivities and a pattern recognition engine as chemical multiplexing for gas sensors [42-44].

### SUMMARY

In a first aspect, the present invention is a sensor array, comprising a plurality of q sensors, a common output lead electrically connected to each sensor, a plurality of m primary input leads each primary input lead electrically connected to n of the plurality of sensors, and a plurality of n secondary input leads each secondary input lead electrically connected to m of the plurality of sensors. The number of sensors q=m·n, m is at least 2, n is at least 2, and each sensor is electrically connected to one of the plurality of primary input leads and one of the plurality of secondary input leads.

In a second aspect, the present invention is a microfluidic device, comprising channels, and a sensor array. The sensor array comprises a plurality of q sensors, a common output lead electrically connected to each sensor, a plurality of m primary input leads each primary input lead electrically connected to n of the plurality of sensors, and a plurality of n secondary input leads each secondary input lead electrically connected to m of the plurality of sensors. The number of sensors q=m·n, m is at least 2, n is at least 2, each sensor is electrically connected to one of the plurality of primary input leads and one of the plurality of secondary input leads, and the sensors are in the channels.

In a third aspect, the present invention is a method of detecting fluid in a channel of a microfluidic device, comprising applying a constant current from input leads to a common output lead and measuring potential between each input lead and the common output lead, or applying a constant potential from the input leads to the common output lead and measuring current flow between each input lead and the common output lead. The microfluidic device comprises a sensor array, and the sensor array comprises a plurality of q sensors, a common output lead electrically connected to each sensor, a plurality of m primary input leads each primary input lead electrically connected to n of the plurality of sensors, and a plurality of n secondary input leads each secondary input lead electrically connected to m of the plurality of sensors. The number of sensors q=m·n, m is at least 2, n is at least 2, each sensor is electrically connected to one of the plurality of primary input leads and one of the plurality of secondary input leads.

### BRIEF DESCRIPTION OF THE DRAWINGS

FIGS. 1(a)-1(d) illustrate a fabrication procedure for a multiplexed array of resistive sensors.

FIG. 2 is a schematic illustrating a multiplexed array of sensors.

FIGS. 3(a) and 3(b) are optical micrographs of a substrate with a multiplexed array of resistive sensors.

FIG. 4 is optical micrograph of a substrate with a multiplexed array of capacitive sensors.

FIGS. 5(a), 5(b) and 5(c) are plug flow detection traces for individual electrical sensors: (a) detection traces for a series of three individual resistive sensors detecting alternating plugs of water and FC-40; (b) detection trace of a single capacitive sensor detecting water and ethanol plugs; (c) detection trace of a single conductive sensor detecting water and ethanol plugs.

FIG. 6 illustrates detection traces for multiplexed resistive sensors detecting a plug of water passing over sensors 1C, 2C and 3C.

FIGS. 7(a), 7(b) and 7(c) illustrate detection traces for multiplexed capacitive sensors detecting a plug of water passing over sensors 1C, 2C, 3B, and 4B: (a) traces for leads 1, 2 and C; (b) traces for leads 3, 4 and B; (c) trances for leads A and D (noise only).

### DETAILED DESCRIPTION

The present invention makes use of the discovery of a multiplexing approach that allows an array of q sensors to be controlled by only m+n+1 electrical leads, where q=m·n, m is at least 2, and n is at least 2. Each sensor element is connected to two input leads (a primary input lead and a secondary input lead), and a common output lead. A first set of m input leads are referred to as the primary input leads, and the remaining n input leads are referred to as the secondary input leads. Each primary input lead is connected to n sensors, and each secondary input lead is connected to m sensors. Since each primary input lead and each secondary input lead is connected to multiple sensor elements, only a few leads are able to control many sensors. The sensor array may be used as a substrate for a microfluidic system, so that the sensors can detect fluid movement or changes in the fluid composition, within the microfluidic channel of the microfluidic system

The multiplexing principle implemented here relies on the fact that each sensing element is connected to two input leads, and each electrical lead is connected to multiple sensors. For a given array of q=m·n sensors, there are m primary input leads (the first set of leads to each sensor), n secondary input leads (the second set of leads to each sensor), and one common output lead for all the sensors. The electrical leads cross over each other without making direct electrical contact, which is accomplished by the use of a thin insulating layer. Each sensor in the array is connected to a unique combination of one primary input lead and one secondary input lead, along with the common output lead. Any particular sensor in the array may be uniquely identified by the primary and secondary input leads to which it is connected; for clarity the primary input leads are identified by a number, 1 through m, and the secondary input leads are identified by a letter, A through the n^{th} letter of the alphabet. For example, the sensor connected to the 2^{nd} primary input lead, and the 4^{th} secondary input lead, may be identified as sensor 2D. In this configuration, when a change in liquid occurs at some sensor ab, a change in the monitored output value is displayed in the trace of both primary input lead a and secondary input lead b, at the same time. This allows one to pinpoint exactly where a liquid element is within a microfluidic system with only m+n+1 sensors, as opposed to having a separate input lead and output lead for each sensing element, which would require 2·m·n total leads. Detecting multiple liquid plugs simultaneously can be accomplished by creating an array of sensors, where each one has a unique size and shape. These geometric differences will result in differences in the magnitudes of the detection peaks for each sensor. This would allow concurrent detection incidences at, for example, sensors 2B and 3C to be distinguished from sensors 2C and 3B.

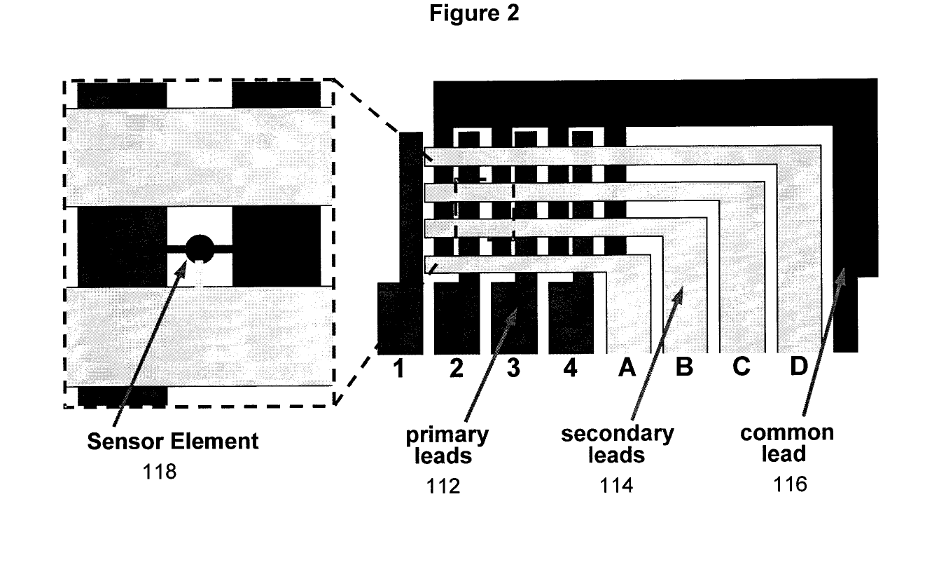

FIG. 2 is a schematic illustrating a multiplexed array of sensors. As shown in FIG. 2, the sensor array includes primary input leads 112 (labeled 1, 2, 3 and 4), secondary input leads 114 (labeled A, B, C and D), and a common output lead 116. A sensor or sensor element 118 is connected to one primary input lead, one secondary input lead, and the common output lead. The input leads, the common output lead, and the sensors, are all on a substrate (not shown). Furthermore, where the leads cross, they are separated by an insulating layer (not shown).

A variety of electrical sensors may be used. Examples included resistive sensors, capacitive sensors, conductive sensors, and electrochemical sensors. Preferably, the electrical sensors are direct current (DC) sensors. Preferably, the array includes at least 4 sensors, more preferably at least 16 sensors, including 25-10,000 sensors, such as 100, 500, 1000, and 5000 sensors. Similarly, the array includes at least 2 primary input leads, more preferably at least 4 primary input leads, including 5-100 primary input leads, such as 10, 20, 25, 50, and 100 primary input leads. Similarly, the array includes at least 2 secondary input leads, more preferably at least 4 secondary input leads, including 5-100 secondary input leads, such as 10, 20, 25, 50, and 100 secondary input leads.

The array of sensors is not required to be arranged as a rectangular grid as illustrated, but may be arranged in any pattern which provides sufficient space to connect the input and output leads to the sensors. For example, the array of sensors may be arranged in a circle, a spiral pattern, or irregularly. Only the connection between the sensor and the primary input lead, the secondary input lead, and the common output lead needs to be maintained. Since the primary input leads may be formed in their own layer, and the secondary input leads may also be formed in their own layer, with an insulating layer separating the primary input leads from the secondary input leads where they cross, almost any arrangement of sensors sufficiently spaced apart may be used. However, the most efficient arrangement would be a rectangular pattern. A design with an irregular number of sensors would be possible, but would not be the most advantageous use of the multiplexing system.

The resistive sensors are similar to traditional thermal resistive heaters typically used as flow and temperature sensors [23, 45-47]. Preferably, these thermal sensors require only a single heater element for detection. (Other thermal flow sensors commonly employ two resistive elements for detection; one to heat the liquid and another to measure the downstream temperature.) To create the sensor, a conductive thin-film serpentine [48] resistor is patterned on a substrate. The conductive material used to form the thin-film serpentine is preferably a metal, such as nickel. The serpentine may be patterned from a film by photolithography. In operation, a small constant potential is applied across the resistor, which quickly heats up to a constant temperature in proportion to its temperature coefficient of resistance (TCR) and the thermal conductivity of the surrounding liquid. As the liquid around the resistor changes (i.e. from air to water, or water to ethanol), so too does the thermal conductivity of the surrounding liquid, also causing the amount of heat transferred away from the resistor to change. The temperature of the resistor will also change, causing the resistance of the resistor to change, and finally the measured output current will also change. Therefore, when a change in the current through a resistor is detected, it signals a change in the liquid contacting the resistor.

A result of the multiplexing design of the resistive sensor circuit is the reduction in the overall sensitivity. Because everything is now connected in parallel, the effect of each sensor is reduced. To compensate for this, preferably the resistors are designed to maximize their detection capability. The change in current (ΔI) for a given resistive sensor due to a thermally induced resistance change is related to resistance by

$$Δ I \sim \frac{{R}_{1} - {R}_{2}}{{R}_{1} {R}_{2}} , \qquad ( 1 )$$

where R₁ is the initial resistance of the resistor under the constant applied potential V, and R₂ is the resistance when a liquid droplet is in contact with the resistor. Equation 1 implies that in order to increase the measured current change, the initial resistance of each sensor should be lowered. This is somewhat counterintuitive because, if the initial resistance were increased, so too would the initial temperature of the resistor, leading to the conclusion that this larger temperature difference between the resistor and liquid would result in larger changes in resistance, and therefore in current as well. However, in this system, the temperature change itself is not important, whereas the amount of heat, q, that is removed from the resistor by the liquid, is important. This heat quotient is equal to the power, P, dissipated by the resistor, as given in Equation 2.

q=P=I²R (2)

Here, the amount of heat absorbed is indeed proportional to the resistance, but is much more dependent on the current passing through the system, which would be decreased by increasing the resistance, according to Ohm's Law. Therefore, any advantage gained by increasing the initial resistance of a resistive sensor will be overshadowed by the negative effect of the reduced current. Therefore, the best design for a resistive sensor is one with a low initial resistance. Preferably, the resistance is high enough so that the heat produced by the resistor is sufficiently larger than the heat generated by the electrical leads. This can be achieved by fabricating the leads out of a highly conductive metal, such as gold, and by patterning them to be as thick and wide as possible.

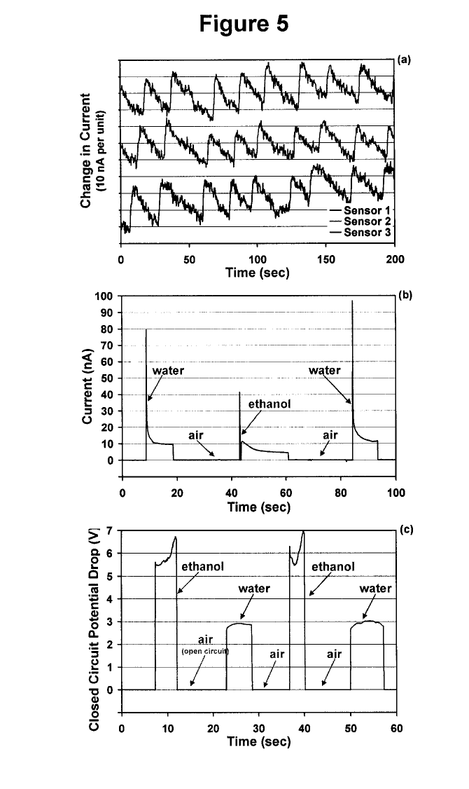

Resistive sensors have an advantage in distinguishing between different liquids when one or more of them is nonconductive. In such situations, conductive sensors cannot be used, and capacitive sensors are generally less sensitive to varying liquid species than are resistive sensors. FIG. 5a shows that resistive sensors can easily differentiate between alternating plugs of water and nonconducting FC-40. Whereas the differences in peaks between water and ethanol for capacitive sensors, shown in FIG. 5b, are less pronounced.

The capacitive sensors preferably have a coplanar geometry, instead of a traditional parallel plate capacitor geometry. Previous work has shown that the maximum capacitive signal in this configuration can be achieved by minimizing the electrode gap spacing, while fabricating electrodes whose exposed width is comparable to the height of the channel surrounding them [30]. Also, Ionescu-Zanetti et al. have presented detailed models for a variety of nanogap capacitive sensors based on device geometry parameters and measured material properties [49]. The capacitors sensors include two coplanar electrodes separated by a small gap over which liquid in a microchannel may pass. While the liquid present in the gap remains the same, equal and opposite charges build up on the ends of the electrodes, and the current is zero. When the liquid changes, the dielectric constant changes as well. To maintain the constant applied potential drop across the gap for this new dielectric constant, the built up charges must instantaneously rearrange. This causes a sudden, sharp, induced current in the circuit that trails off rapidly as the charges on the electrodes equilibrate again. It is this spike in current that is being detected in order to sense a change in liquid with these capacitive sensors.

Capacitive sensing based on an induced current is much simpler than other mostly AC-based capacitance methods. For example, capacitance can be determined by applying an AC potential across the electrode gap and measuring the changes in current. Capacitance is then the constant of proportionality between the two. Alternatively, capacitance can be measured by applying a constant current to the capacitor circuit and monitoring the change in potential as a function of time. Here, changes in liquid would appear as changes in the slope of the output value over time, which is much more difficult to detect than changes in a value's overall magnitude. For both of these situations the electrical setup required can be quite complicated and produce exceedingly small signals, thereby requiring the use of electrical shielding apparatus and precise temperature control. There are commercially available AC capacitance bridges [29, 31] that can automatically overcome some of these problems and directly monitor changes in capacitance in real time, but they are very expensive compared to other detection methods.

One aspect to consider in the design of multiplexed coplanar capacitive system is the geometry of the sensors themselves. The fundamental difference between the multiplexed resistive system and a multiplexed capacitive system is that, in the resistive case, both of the leads for a given sensor element are connected to the same resistor. In the capacitive case however, both leads cannot be connected to the same electrode gap, because that would mean that both of the lead electrodes would be directly connected to each other, and the system would be shorted out. Therefore, in order to achieve a multiplexed capacitive system, there must be two completely separate electrodes, each connected to its own electrode gap with the common output electrode. This results in two electrode gaps for a single sensing element.

The placement and orientation of these two gaps is important. The gaps need to be positioned in such a way that a small plug of liquid passing over them will activate both electrode circuits, and do so at essentially the same time. If the gaps are spaced too far apart then the signals for the two lead traces for a given sensor element will not occur at the same time, thereby defeating the purpose of the multiplexing arrangement. However, the electrodes leading up to the gaps must also be isolated enough from each other so that their interaction does not interfere with the rest of the sensing process. If the gap between the two electrodes themselves acts as a capacitor, the sensing capabilities of the gaps between each electrode and the common output electrode can be severely impaired.

As with the coplanar capacitive sensors, the conductive sensors include two coplanar electrodes separated by a small gap. A small constant current is applied between the electrodes while the potential drop across the gap is monitored. When the fluid filling the electrode gap is nonconductive, the system acts like an open circuit and the measured potential drop is infinite. When a conductive liquid fills the gap, the circuit is closed and a potential drop is detected proportional to the conductivity of the liquid.

Conductivity sensors can only be used to detect electrically conductive liquids. However, within the realm of conductive liquids, conductive sensing has the strongest signals, the largest signal to noise ratios, and is the most sensitive to different liquids, when compared to resistive and capacitive sensing. This can be seen in the very large, sharp, and consistent detection peaks shown in FIG. 5c.

Capacitive and conductive sensors can theoretically be scaled down to much smaller length scales than their resistive counterparts. The sensing element in the capacitive and conductive cases is merely a small gap between two coplanar electrodes. This is in contrast to the intricate serpentine pattern used for resistors, which only becomes more difficult to create when critical length scales approach the sub micron regime.

Analyte sensors use electrochemistry, often with the aid of enzymes at the electrodes, to determine the quantity or concentration of an analyte. As with the coplanar capacitive sensors and conductive sensors, the analyte sensors include two coplanar electrodes separated by a small gap over which liquid in a microchannel may pass. Analyte concentration can be measured by applying a constant DC potential across the gap and the corresponding current is monitored as a function of time.

Once the electrodes have been formed on a substrate, for example having the same structure as those of the coplanar capacitive sensors, they may be coated with a reagent. The selection of the reagent is used to provide electrochemical probes for specific analytes. The reagent may be as simple as a single enzyme, such as glucose oxidase or glucose hydrogenase for the detection of glucose. Preferably, the enzyme is immobilized as described in PCT International Publication no. WO 96/06947. The reagent may optionally also include a mediator, to enhance sensitivity of the sensor. Optionally, the enzyme and/or mediator may be added to the liquid in the microfluidic system, which contains the analyte to be measure, rather than added to the reagent.

Analyte sensors are well known, particularly glucose sensors, and are described in, for example, U.S. Pat. Nos. 5,387,327; 5,411,647; and 5,476,776; as well as in PCT International Publication nos. WO 91/15993; WO 94/20602; WO 96/06947; and WO 97/19344. Furthermore, a variety of analytes, and the enzymes and mediators used for their detection, are described in U.S. Pat. No. 6,405,066.

The sensor array may be used as the substrate for a microfluidic device. A microfluidic device contains channels with a cross sectional area of at most 1 mm², preferably at most 50,000 μm², more preferably at most 10,000 μm². These devices are typically capable of performing electrophoretic separations and fluidic manipulation, and are described in, for example, “HYBRID MICROFLUIDIC AND NANOFLUIDIC SYSTEM” to Paul W. Bohn et al., Published Patent Application, publication no. US 2003-0136679, published 24 Jul. 2003; “MULTILAYER MICROFLUIDIC-NANOFLUIDIC DEVICE” to Bruce R. Flachsbart et al., U.S. patent application Ser. No. 11/375,525 filed 14 Mar. 2006; and have been previously described [53, 54].

### EXAMPLES

To demonstrate the multiplexing, 4×4 arrays of resistive and coplanar capacitive sensors were integrated into microfluidic systems to monitor the passage of discrete liquid plugs. The microfluidic devices containing a multiplexed resistive sensor array included two components, a flexible thin-film polyimide (KAPTON® 500 HN, DuPont®, Wilmington, Del.) substrate supporting the sensors and electrical interconnects, and a poly(dimethylsiloxane) (PDMS) mold defining the microfluidic channels of the microfluidic system. The polyimide film has a very low thermal conductivity (0.12 W/m·K) and serves to promote heat transfer from the resistor to the surrounding liquid by deterring heat transfer into the substrate [24, 26, 50]. This helps to make the sensors much more sensitive to subtle changes in the liquid. Other techniques exist to thermally insulate resistive sensors in microfluidic devices without the use of a polyimide substrate, such as removing the substrate material directly beneath the sensor to leave it suspended in air [24, 51, 52]. However these processes require several additional fabrication steps and typically result in physically weaker sensors.

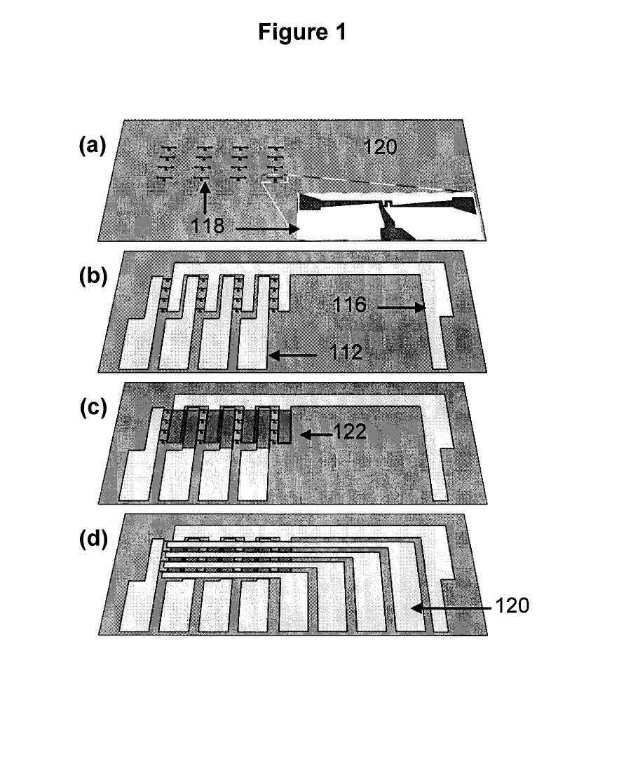

The sensors and leads were patterned using three standard lift-off procedures, as shown in FIG. 1. First, the individual resistors were defined in 0.5 μm thick positive photoresist (Rohm & Haas S1805) and then 80 nm of Ni was deposited by electron-beam evaporation (Temescal FC-1800) to form the resistors. The excess photoresist and metal was removed by sonication in an acetone bath. Nickel was chosen as the metal for the resistors because of its relatively low intrinsic electrical resistivity and a relatively high TCR. This combination produces the largest possible change in current for a given change in temperature among the metals commonly used in microfabrication (Au, Pt, Ti, etc.). The primary leads were defined similarly by lift-off. The leads included a 35 Å thick Ti adhesion layer, followed by 100 nm of Au, and finally an additional 75 Å thick layer of Ti used to render the lead surface more liquiphilic for future processing steps.

Next, a 4 μm thick layer of SU-8 negative photoresist (Microchem, Newton, Mass.) was patterned over the areas of the first set of electrodes that would intersect with the secondary leads. The SU-8 served to electrically insulate the two sets leads from each other. The thickness of the SU-8 layer was chosen so that it would be thick enough to be free of through holes and other defects in order to guarantee proper insulation between electrode layers. The layer also needed to be thin enough so that the secondary leads to be deposited would be continuous over it. If the layer were too thick, the metal deposited would only cover the top of the SU-8 and the surface of the substrate, and not the sidewalls of the SU-8 layer. The secondary leads were patterned using another lift-off step. To ensure that the leads would be conformally coated over the SU-8, a much thicker layer of photoresist (10 μm, Shipley® SJR-5740) was used to define them. This allowed for a much thicker layer of metal to be deposited without compromising the lift-off process. Also, the secondary leads (35 Å Ti adhesion layer followed by 300 nm Au) were deposited using a sputtering process instead of an evaporation deposition, because sputtering is a much more isotropic process than evaporation. This allowed for the sidewalls of the SU-8 layer to be sufficiently coated with metal instead of only the surfaces normal to the deposition target.

Preliminary resistive sensor devices including non-multiplexed sensors were fabricated simply by first patterning the individual resistors in an 80 nm nickel layer via lift-off, followed by a 35 Å Ti/100 nm Au electrode layer. For multiplexed resistive sensors, the widths of the gold leads connected to the resistive sensors were 1.65 mm each. The resistors were of a serpentine geometry, having a total overall path length of 1.2 mm, with a cross-sectional width of 30 μm. They had a horizontal pitch of 5 mm and a vertical pitch of 3 mm.

A coplanar geometry [30] was used for the capacitive sensors because of the advantages in microfabrication. The widths of the electrical leads (150 μm) were much smaller than those of the sensors themselves (1 mm), thereby minimizing any unwanted effects the leads may cause. The gap between each input electrode of the sensor and the output electrode was 50 μm. These sensors had a pitch of 5 mm in both the horizontal and vertical directions.

For the capacitive sensors, the regions of the leads closest to the sensor elements were patterned so that they intersect the overlaying microfluidic channels as minimally as possible. If a charged lead is consistently contacted with liquid, the highly sensitive induced current detection process occurring at the specified electrode gaps will be interfered with. This problem was avoided by patterning the intersecting regions with an electrically insulating SU-8 film.

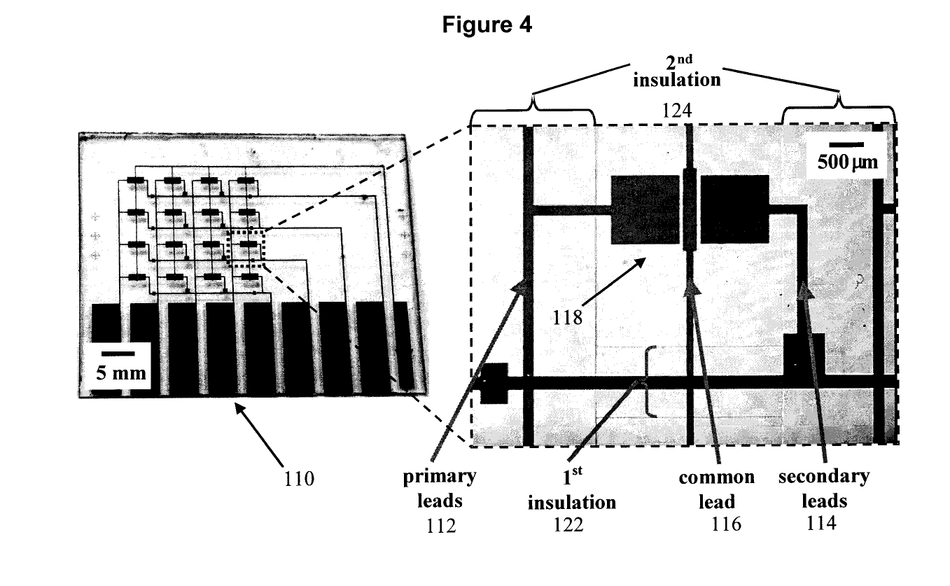

The fabrication steps used to create the capacitive and conductive sensing devices were essentially identical. A clean glass microscope slide was used as the substrate. The sensor elements and primary leads were a 35 Å Ti, 100 nm Au, and 75 Å Ti layer patterned by lift-off. An SU-8 insulation layer was then patterned as described above, followed by the sputter deposition of the secondary leads, including a 35 Å Ti adhesion layer and 300 nm Au. A second 4 μm thick SU-8 insulating layer was patterned over the exposed leads to prevent interference with liquid passing over them during testing. Finally, the PDMS microfluidic mold was aligned and placed on the substrate as described above. FIG. 4 shows a completed multiplexed capacitive or conductive sensing substrate. Both the sensors and the leads for non-multiplexed capacitive and conductive devices were patterned by a single lift-off step of a 35 Å Ti/100 nm Au layer.

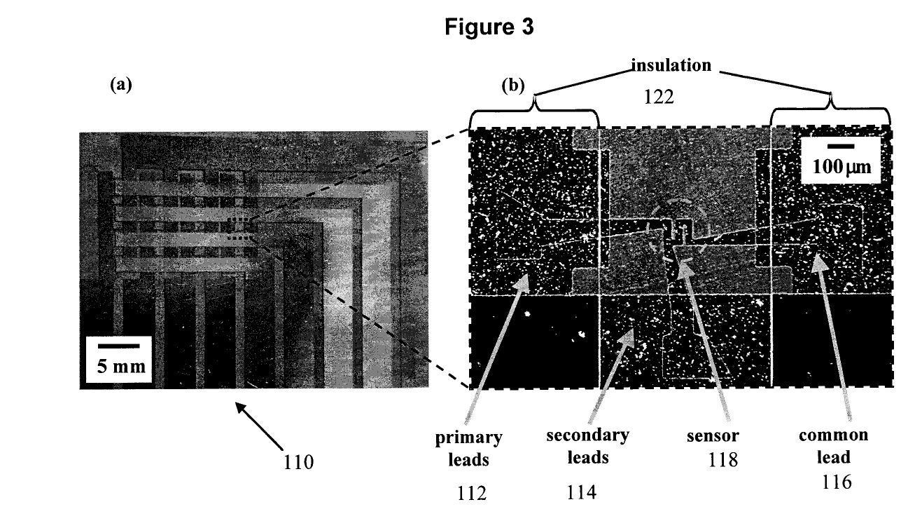

The PDMS mold (Sylgard 184, Dow Corning, Midland, Mich.) containing the microfluidic network was prepared via replica molding as has been previously reported [53, 54]. The PDMS mold and the substrate were then aligned and brought into reversible contact using a custom-built four-axis micro-aligner. FIG. 3 shows a completed multiplexed resistive sensing substrate before being attached to the PDMS microfluidic mold.

Data for the resistive and capacitive devices was collected on a PC using a custom-built power supply controlled by a LabVIEW program. A given device was connected to the power supply via a standard 34-pin socket connector. The system was capable of applying a constant potential of between 1 and 100 mV to up to 8 different electrical channels and recording the resulting current through each individual circuit. While each channel had its own electrical lead from the power supply, all eight channels were connected to the same common output electrode to both reduce the number of external electrical contacts necessary for a given sensor array, and to simplify the electronics in the power supply. The system was designed to detect nano-Ampere (nA), long-period current fluctuations atop micro-Ampere baseline currents in 8 channels. A computer generated 8-bit DAC voltage was converted to a constant baseline current of 0 to 1000 μA, which was supplied to all 8 channels. The current through each of the 8 channels was read as a voltage by the computer. Since this baseline current is large with respect to the fluctuations to be detected, an “auto zero” circuit was used. When activated, the “auto zero” circuit steps through all states of 3 cascaded 8 bit DAC's adding or subtracting from the baseline reading on all 8 channels, until a 24 bit offset value is stored for each. In this zeroed condition, the computer, via 8 channels of 12 bit A/D's (Labjack U3), can monitor slowly varying current changes with a resolution of about 1 nA on all channels simultaneously.

Data for the conductive sensor devices was collected using an Autolab® Potentiostat PGSTAT30. Because this apparatus only had one channel, it was possible to only test a single individual sensor at a time for devices based on conductive detection.

Fluid was introduced to the device through a 0.022 in I.D. polyethylene tube attached to a syringe. The tubing was inserted into inlet holes in the PDMS that had been punched before the mold was placed on the substrate. The flow rate of the injected fluid was controlled with a syringe pump (Harvard Apparatus, Holliston, Mass.).

FIG. 5 shows typical detection traces for the three types of individual electrical sensors in a microchannel when the liquid contacting a given sensor changes. FIG. 5a depicts data for a device containing a series of three resistive sensors in a 250 μm wide microchannel. Alternating 5 μL plugs [55, 56] of deionized water and a low thermal conductivity fluorinated solvent (Fluorinert™ FC-40, 3M™, St. Paul, Minn.) were allowed to flow over the resistive sensors and the current across each was monitored for a constant applied potential of 30 mV. The effective change in current through each resistive sensors was enhanced by the use of a low thermal conductivity polyimide substrate (Kapton®) and a metal with a large TCR (Ni). Each complete spike in current represents the passage of one plug of water and one plug of FC-40 over a resistive sensors. Since the thermal conductivity of water (0.6 W/m·K) is greater than that of the FC-40 (0.06 W/m·K), the sections of the current traces that are increasing indicate times when a given sensor is surrounded by water and is cooling down. Decreases in current correspond to the FC-40 contacting the sensor and the sensor heating up. Also note that the magnitude of the slope when the current is increasing is much greater than the magnitude of the slope when the current is decreasing. This is again due to the differences in thermal conductivities of the two liquids. Because water has a higher thermal conductivity than the FC-40, not only will the net heat transfer from the resistive sensor to the water be greater (resulting in a lower temperature), it will be faster as well. The resistive sensor therefore cools down faster in the presence of water than it heats up in the presence of FC-40. This also explains the slight upward trend observed in the overall current traces. Since the current will increase slightly more and slightly faster when detecting a water plug than it will decrease when detecting an FC-40 plug, there will be a small net increase in current for each water/FC-40 iteration.

For a coplanar capacitive sensor, the change of dielectric constant resulting from a change of liquid between the electrodes leads to a very sharp and quick induced current. The magnitude of this current is proportional to the dielectric constant of the liquid and immediately begins to trail off after initially peaking at its maximum value. After the system again reaches an equilibrium state, the measured current settles at some nominal value as a result of the conductivity of the liquid. FIG. 5b shows the response from a single capacitive sensor over which alternating 5 μL plugs of water (ε_{water}=80), air (εₐᵢᵣ=1), and ethanol (εₑₜₕₐₙₒₗ=24) were allowed to flow. The fact that the specific values of the induced currents are not identical for both water peaks is a result of the highly transient nature of this induced current behavior, coupled with the resolution limit of the data acquisition system.

FIG. 5c shows a typical response of a conductive sensor in a microchannel. Alternating 5 μL plugs of water, air, and ethanol were passed over a single conductive sensor in a microchannel. These sensors are essentially on-off switches. When the liquid between the electrodes is nonconductive, the circuit is open. When a conductive liquid fills the gap, the circuit is closed and a potential drop proportional to the conductivity of the liquid is observed.

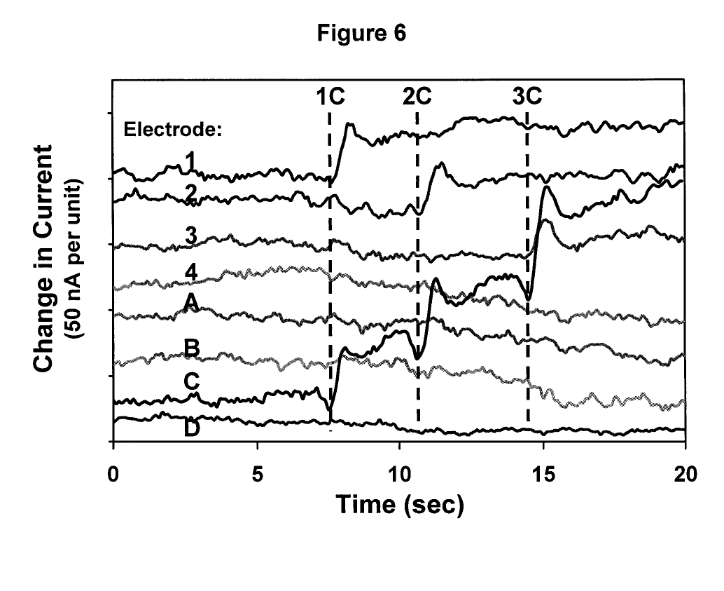

In a device similar to that shown in FIG. 3, a 1 μL water plug was flown through a channel over sensors 1C, 2C, and 3C at a flow rate of 2 mL/hr (˜0.1 cm/s) while a DC potential of 75 mV was applied to each lead. Typical detection traces for such an experiment are shown in FIG. 6. Each pair of current rises that occur at the same time represent the water plug flowing over the specific sensor defined by those two leads. FIG. 6 clearly shows the system's ability to use electrical sensors to accurately track a discrete plug of liquid throughout a complex two-dimensional microfluidic network while using a minimal number of external electrical connections. That the current traces for the affected leads do not return to their baseline values after the water plug has completely passed over them was again due to the large difference in thermal conductivity between water and air; the resistive sensors will cool down much faster in water than they will heat up in air.

The massively parallel nature of the multiplexing arrangement also gives rise to some other interesting characteristics in the resistive sensor detection traces. In FIG. 6, when the current for a given pair of leads increases as a result of the liquid plug removing heat from the resistive sensor, some of the other leads' current traces also undergo minor fluctuations. This is due to the fact that all of the resistive sensors are connected to multiple leads and to the same output electrode. When the current in one element of the circuit increases, the other closely connected leads are also affected. Therefore, when a liquid plug is detected in the multiplexed resistive sensor system, two large peaks representing the position of the plug are prevalent, and several small decreases in current appear, which is a remnant of the interconnectedness of the system.

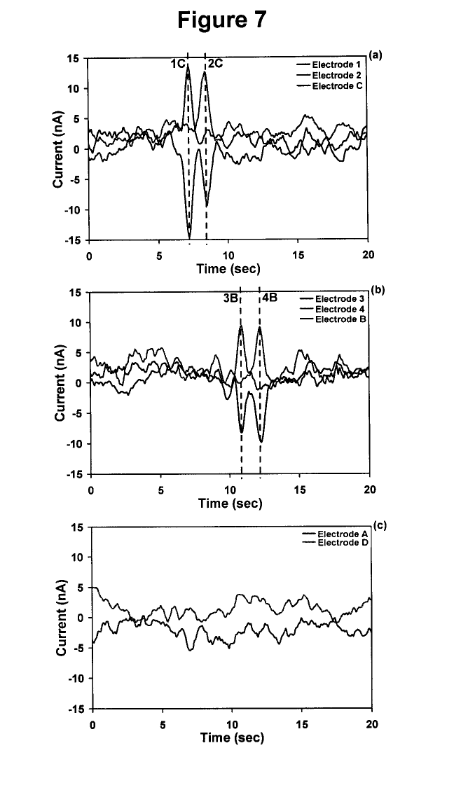

To test the capacitive multiplexing system, a 1 μL water plug was flown through a channel over sensors 1C, 2C, 3B, and 4B at a flow rate of 1.5 mL/hr (˜0.1 cm/s) while a DC potential of 100 mV was applied to each lead. The resulting detection traces are shown in FIG. 7. The traces have been distributed between three different charts for clarification. This data was taken at a rate of 10 Hz and the noise was filtered out using a 5-point boxcar averaging method. Each pair of positive and negative current spikes occurring at the same time represents the liquid plug passing over the sensor denoted by those particular leads. The positive current spike always comes from the primary lead of the pair, and the negative spike from the secondary lead. This trend arises because of the narrowness of the output electrode (200 μm). With the two leads being so close together, they interact with each other as well as with the output electrode, meaning that the positive current in the primary lead imposes a negative current in the secondary lead. This effect could be avoided by either making the output electrode wider, or by making the lead electrode sensor areas smaller. However, the former would result in an unnecessarily larger sensor, and the later would produce weaker signals.

### REFERENCES

[1] M. U. Kopp, A. J. De Mello, A. Manz, Chemical amplification: Continuous-flow pcr on a chip, Science 280 (1998) 1046-1048.
[2] N. A. Lacher, K. E. Garrison, R. S. Martin, S. M. Lunte, Microchip capillary electrophoresis/electrochemistry, Electrophoresis 22 (2001) 2526-2536.
[3] S. Gawad, L. Schild, P. Renaud, Micromachined impedance spectroscopy flow cytometer for cell analysis and particle sizing, Lab on a Chip 1 (2001) 76-82.
[4] T. Thorsen, S. J. Maerkl, S. R. Quake, Microfluidic large-scale integration, Science 298 (2002) 580-584.
[5] E. R. Choban, L. J. Markoski, A. Wieckowski, P. J. A. Kenis, Microfluidic fuel cell based on laminar flow, Journal of Power Sources 128 (2004) 54-60.
[6] J. Su, M. R. Bringer, R. F. Ismagilov, M. Mrksich, Combining microfluidic networks and peptide arrays for multi-enzyme assays, Journal of the American Chemical Society 127 (2005) 7280-7281.
[7] J.-s. Han, Z.-y. Tan, K. Sato, M. Shikida, Three-dimensional interconnect technology on a flexible polyimide film, J. Micromech. Microeng. 14 (2004) 38-48.
[8] K. Swinney, D. J. Bornhop, Detection in capillary electrophoresis, Electrophoresis 21 (2000) 1239-1250.
[9] M. A. Schwarz, P. C. Hauser, Recent developments in detection methods for microfabricated analytical devices, Lab on a Chip 1 (2001) 1-6.
[10] S. Kulmala, J. Suomi, Current status of modern analytical luminescence methods, Analytica Chimica Acta 500 (2003) 21-69.
[11] E. Verpoorte, Chip vision—optics for microchips, Lab on a Chip 3 (2003) 42N-52N.
[12] K. B. Mogensen, H. Klank, J. P. Kutter, Recent developments in detection for microfluidic systems, Electrophoresis 25 (2004) 3498-3512.
[13] A. T. Woolley, K. Lao, A. N. Glazer, R. A. Mathies, Capillary electrophoresis chips with integrated electrochemical detection, Analytical Chemistry 70 (1998) 684-688.
[14] A. Hilmi, J. H. T. Luong, Electrochemical detectors prepared by electroless deposition for microfabricated electrophoresis chips, Analytical Chemistry 72 (2000) 4677-4682.
[15] A. J. Gawron, R. S. Martin, S. M. Lunte, Fabrication and evaluation of a carbon-based dual-electrode detector for poly(dimethylsiloxane) electrophoresis chips, Electrophoresis 22 (2001) 242-248.
[16] N. A. Lacher, S. M. Lunte, R. S. Martin, Development of a microfabricated palladium decoupler/electrochemical detector for microchip capillary electrophoresis using a hybrid glass/poly(dimethylsiloxane) device, Analytical Chemistry 76 (2004) 2482-2491.
[17] R. M. Guijt, E. Baltussen, G. Van der Steen, R. B. M. Schasfoort, S. Schlautmann, H. A. H. Billiet, J. Frank, G. W. K. Van Dedem, A. Van den Berg, New approaches for fabrication of microfluidic capillary electrophoresis devices with on-chip conductivity detection, Electrophoresis 22 (2001) 235-241.
[18] M. Galloway, W. Stryjewski, A. Henry, S. M. Ford, S. Llopis, R. L. McCarley, S. A. Soper, Contact conductivity detection in poly(methyl methacrylate)-based microfluidic devices for analysis of mono- and polyanionic molecules, Analytical Chemistry 74 (2002) 2407-2415.
[19] J. Lichtenberg, N. F. de Rooij, E. Verpoorte, A microchip electrophoresis system with integrated in-plane electrodes for contactless conductivity detection, Electrophoresis 23 (2002) 3769-3780.
[20] J. Tanyanyiwa, S. Leuthardt, P. C. Hauser, Conductimetric and potentiometric detection in conventional and microchip capillary electrophoresis, Electrophoresis 23 (2002) 3659-3666.
[21] R. Tantra, A. Manz, Integrated potentiometric detector for use in chip-based flow cells, Analytical Chemistry 72 (2000) 2875-2878.
[22] R. Ferrigno, J. N. Lee, X. Jiang, G. M. Whitesides, Potentiometric titrations in a poly(dimethylsiloxane)-based microfluidic device, Analytical Chemistry 76 (2004) 2273-2280.
[23] J. J. van Baar, R. J. Wiegerink, T. S. J. Lammerink, G. J. M. Krijnen, M. Elwenspoek, Micromachined structures for thermal measurements of fluid and flow parameters, J. Micromech. Microeng. 11 (2001) 311-318.
[24] J.-s. Han, T. Kadowaki, K. Sato, M. Shikida, Fabrication of thermal-isolation structure for microheater elements applicable to fingerprint sensors, Sensors and Actuators, A: Physical A100 (2002) 114-122.
[25] J. J. van Baar, W. A. Verweij, M. Dijkstra, R. J. Wiegerink, T. S. J. Lammerink, G. J. M. Krijnen, M. Elwenspoek, Micromachined two dimensional resistor arrays for determination of gas parameters, Digest of Technical Papers, Transducers '03, International Conference on Solid-State Sensors, Actuators and Microsystems, Boston, Mass., United States, Jun. 8-12, 2003.
[26] J.-s. Han, Z.-y. Tan, K. Sato, M. Shikida, Thermal characterization of micro heater arrays on a polyimide film substrate for fingerprint sensing applications, J. Micromech. Microeng. 15 (2005) 282-289.
[27] O. Berberig, K. Nottmeyer, J. Mizuno, Y. Kanai, T. Kobayashi, The prandtl micro flow sensor (pmfs): A novel silicon diaphragm capacitive sensor for flow-velocity measurement, Sensors and Actuators, A: Physical A66 (1998) 93-98.
[28] M. N. Horenstein, J. A. Perreault, T. G. Bifano, Differential capacitive position sensor for planar mems structures with vertical motion, Sensors and Actuators, A: Physical A80 (2000) 53-61.
[29] L. L. Sohn, O. A. Saleh, G. R. Facer, A. J. Beavis, R. S. Allan, D. A. Notterman, Capacitance cytometry: Measuring biological cells one by one, Proceedings of the National Academy of Sciences 97 (2000) 10687-10690.
[30] J. Z. Chen, A. A. Darhuber, S. M. Troian, S. Wagner, Capacitive sensing of droplets for microfluidic devices based on thermocapillary actuation, Lab on a Chip 4 (2004) 473-480.
[31] R. Kapon, I. Sagiv, J. Shappir, N. Mazorski, G. Ziv, D. Shahar, Z. Reich, Method to sense single-particle motion using a tapered-gap microcapacitor, Applied Physics Letters 84 (2004) 4277-4279.
[32] W. Olthuis, W. Streekstra, P. Bergveld, Theoretical and experimental determination of cell constants of planar-interdigitated electrolyte conductivity sensors, Sensors and Actuators, B: Chemical B24 (1995) 252-6.
[33] B. K. Gale, K. D. Caldwell, A. B. Frazier, Electrical conductivity particle detector for use in biological and chemical micro-analysis systems, Proceedings of SPIE—The International Society for Optical Engineering 3515 (1998) 230-241.
[34] V. Haguet, D. Martin, L. Marcon, T. Heim, D. Stievenard, C. Olivier, O. El-Mahdi, O. Melnyk, Combined nanogap nanoparticles nanosensor for electrical detection of biomolecular interactions between polypeptides, Applied Physics Letters 84 (2004) 1213-1215.
[35] J. Collins, A. P. Lee, Microfluidic flow transducer based on the measurement of electrical admittance, Lab on a Chip 4 (2004) 7-10.
[36] J. D. Beck, L. Shang, M. S. Marcus, R. J. Hamers, Manipulation and real-time electrical detection of individual bacterial cells at electrode junctions: A model for assembly of nanoscale biosystems, Nano Letters 5 (2005) 777-781.
[37] G. Marchand, C. Delattre, R. Campagnolo, P. Pouteau, F. Ginot, Electrical detection of DNA hybridization based on enzymatic accumulation confined in nanodroplets, Analytical Chemistry 77 (2005) 5189-5195.
[38] N. Srivastava, M. A. Burns, Electronic drop sensing in microfluidic devices: Automated operation of a nanoliter viscometer, Lab on a Chip 6 (2006) 744-751.
[39] Y. Mo, Y. Okawa, K. Inoue, K. Natukawa, Low-voltage and low-power optimization of micro-heater and its on-chip drive circuitry for gas sensor array, Sensors and Actuators, A: Physical A100 (2002) 94-101.
[40] C. H. Shen, C. Gau, Heat exchanger fabrication with arrays of sensors and heaters with its micro-scale impingement cooling process analysis and measurements, Sensors and Actuators, A: Physical A114 (2004) 154-162.
[41] J.-J. Park, M. Taya, Design of micro-temperature sensor array with thin film thermocouples, Journal of Electronic Packaging 127 (2005) 286-289.
[42] M. Penza, G. Cassano, F. Tortorella, Gas recognition by activated wo3 thin-film sensors array, Sensors and Actuators, B: Chemical B81 (2001) 115-121.
[43] E. Llobet, P. Ivanov, X. Vilanova, J. Brezmes, J. Hubalek, K. Malysz, I. Gracia, C. Cane, X. Correig, Screen-printed nanoparticle tin oxide films for high-yield sensor Microsystems, Sensors and Actuators, B: Chemical B96 (2003) 94-104.
[44] M. Stankova, P. Ivanov, E. Llobet, J. Brezmes, X. Vilanova, I. Gracia, C. Cane, J. Hubalek, K. Malysz, X. Correig, Sputtered and screen-printed metal oxide-based integrated micro-sensor arrays for the quantitative analysis of gas mixtures, Sensors and Actuators, B: Chemical B103 (2004) 23-30.
[45] L. Jiang, W. Man, Y. Zohar, Micromachined polycrystalline thin-film temperature sensors, Measurement Science and Technology 10 (1999) 653-664.
[46] K.-D. Song, B.-S. Joo, N.-J. Choi, Y.-S. Lee, S.-M. Lee, J.-S. Huh, D.-D. Lee, A micro hot-wire sensors for gas sensing applications, Sensors and Actuators, B: Chemical B102 (2004) 1-6.
[47] S. He, M. M. Mench, S. Tadigadapa, Thin film temperature sensor for real-time measurement of electrolyte temperature in a polymer electrolyte fuel cell, Sensors and Actuators, A: Physical A125 (2006) 170-177.
[48] W. C. Shin, R. S. Besser, A micromachined thin-film gas flow sensor for microchemical reactors, J. Micromech. Microeng. 16 (2006) 731-741.
[49] C. Ionescu-Zanetti, J. T. Nevill, D. Di Carlo, K. H. Jeong, L. P. Lee, Nanogap capacitors. Sensitivity to sample permittivity changes, Journal of Applied Physics 99 (2006) 024305/1-024305/5.
[50] M. Aslam, C. Gregory, J. V. Hatfield, Polyimide membrane for micro-heated gas sensor array, Sensors and Actuators, B: Chemical B103 (2004) 153-157.
[51] H. R. Chen, C. Gau, B. T. Dai, M. S. Tsai, A monolithic fabrication process for a micro-flow heat transfer channel suspended over an air layer with arrays of micro-sensors and heaters, Sensors and Actuators, A: Physical A108 (2003) 81-85.
[52] D. N. Pagonis, A. G. Nassiopoulou, G. Kaltsas, Porous silicon membranes over cavity for efficient local thermal isolation in si thermal sensors, Journal of the Electrochemical Society 151 (2004) H174-H179.
[53] D. Qin, Y. Xia, G. M. Whitesides, Rapid prototyping of complex structures with feature sizes larger than 20 mm, Advanced Materials 8 (1996) 917-919.
[54] Y. Xia, G. M. Whitesides, Soft lithography, Angewandte Chemie 37 (1998) 550-575.
[55] J. D. Tice, H. Song, A. D. Lyon, R. F. Ismagilov, Formation of droplets and mixing in multiphase microfluidics at low values of the reynolds and the capillary numbers, Langmuir 19 (2003) 9127-9133.
[56] T. Thorsen, R. W. Roberts, F. H. Arnold, S. R. Quake, Dynamic pattern formation in a vesicle-generating microfluidic device, Physical Review Letters 86 (2001) 4163-4166.

What is claimed is:

1. A sensor array, comprising:
a plurality of q sensors,
a common output lead, electrically connected to each sensor,
a plurality of m primary input leads, each primary input lead electrically connected to n of the plurality of sensors, and
a plurality of n secondary input leads, each secondary input lead electrically connected to m of the plurality of sensors,
wherein q=m·n, m is at least 2, n is at least 2, and
each sensor is electrically connected to one of the plurality of primary input leads and one of the plurality of secondary input leads.

2. The sensor array of claim 1, wherein m is at least 4, and n is at least 4.

3. The sensor array of claim 2, wherein m is 5-100.

4. The sensor array of claim 2, wherein n is 5-100.

5. The sensor array of claim 1, wherein m is 4-100, and n is 4-100.

6. The sensor array of claim 1, wherein the sensors are selected from the group consisting of resistive sensors, capacitive sensors and conductive sensors.

7. The sensor array of claim 1, wherein the sensors are selected from the group consisting of resistive sensors and capacitive sensors.

8. The sensor array of claim 1, wherein the sensors are resistive sensors, and each resistive sensor comprises a single heater element.

9. The sensor array of claim 1, wherein the sensors are capacitive sensors, and each sensor comprises:
a first input electrode,
a second input electrode, and
a common output electrode, between the first and second input electrodes.

10. The sensor array of claim 9, wherein the first input electrode is connected to the primary input lead, the second input electrode is connected to the secondary input lead, and the common output electrode is connected to the common output lead.

11. A microfluidic device, comprising:
channels, and
a sensor array,
wherein the sensor array comprises:
a plurality of q sensors,
a common output lead, electrically connected to each sensor,
a plurality of m primary input leads, each primary input lead electrically connected to n of the plurality of sensors, and
a plurality of n secondary input leads, each secondary input lead electrically connected to m of the plurality of sensors,
q=m·n, m is at least 2, n is at least 2,
each sensor is electrically connected to one of the plurality of primary input leads and one of the plurality of secondary input leads, and
the sensors are in the channels.

12. The microfluidic device of claim 11, wherein m is at least 4, and n is at least 4.

13. The microfluidic device of claim 12, wherein m is 5-100.

14. The microfluidic device of claim 12, wherein n is 5-100.

15. The microfluidic device of claim 11, wherein m is 4-100, and n is 4-100.

16. The microfluidic device of claim 11, wherein the sensors are selected from the group consisting of resistive sensors, capacitive sensors and conductive sensors.

17. The microfluidic device of claim 11, wherein the sensors are selected from the group consisting of resistive sensors and capacitive sensors.

18. The microfluidic device of claim 11, wherein the sensors are resistive sensors, and each resistive sensor comprises a single heater element.

19. The microfluidic device of claim 11, wherein the sensors are capacitive sensors, and each sensor comprises:
a first input electrode,
a second input electrode, and
a common output electrode, between the first and second input electrodes.

20. The microfluidic device of claim 19, wherein the first input electrode is connected to the primary input lead, the second input electrode is connected to the secondary input lead, and the common output electrode is connected to the common output lead.

21. A method of making a microfluidic device, comprising:
forming a substrate comprising a sensor array of claim 1, and
forming a microfluidic device comprising the substrate,
wherein the sensors are in channels of the microfluidic device.

22. A method of detecting fluid in a channel of a microfluidic device, comprising:
applying a constant current from input leads to a common output lead and measuring potential between each input lead and the common output lead, or applying a constant potential from the input leads to the common output lead and measuring current flow between each input lead and the common output lead;
wherein the microfluidic device comprises a sensor array,
the sensor array comprises:
a plurality of q sensors,
a common output lead, electrically connected to each sensor,
a plurality of m primary input leads, each primary input lead electrically connected to n of the plurality of sensors, and
a plurality of n secondary input leads, each secondary input lead electrically connected to m of the plurality of sensors,
q=m·n, m is at least 2, n is at least 2,
each sensor is electrically connected to one of the plurality of primary input leads and one of the plurality of secondary input leads.

23. The method of claim 22, wherein m is at least 4, and n is at least 4.

24. The method of claim 22, wherein m is 4-100, and n is 4-100.

25. The method of claim 22, wherein the sensors are selected from the group consisting of resistive sensors, capacitive sensors and conductive sensors.
